(19) United States
(12) Patent Application Publication
(10) Pub. No.: US 2014/0373987 A1
(43) Pub. Date: Dec. 25, 2014

(54) Emergency Identification Card Holder

(71) Applicant: Shawn Hubert Ming, Alberton (ZA)

(72) Inventor: Shawn Hubert Ming, Alberton (ZA)

(21) Appl. No.: 14/115,762

(22) PCT Filed: May 7, 2012
(86) PCT No.: PCT/IB2012/052257

§ 371 Date: Feb. 27, 2014

(30) Foreign Application Priority Data
May 5, 2011 (ZA) 2011/03267

(51) Int. Cl. A45C 11/18; B60R 11/00; A45F 5/02

(52) U.S. Cl. CPC A45C 11/18; A45F 5/021; B60R 11/00; B60R 2011/0031; B60R 2011/0059
USPC 150/149

(57) ABSTRACT

Disclosed is an identification card holder, and more particularly, an emergency identification holder suitable for being removably secured to a safety belt of a motor vehicle. The holder includes two cover members pivotably secured to one another, the cover members are displaceable between an open position in which the two cover members are angularly spaced apart and in which information housed inside the holder can be accessed, and a closed position in which the two cover members are substantially parallel and overlie one another. The holder includes a fastener for fastening the two rigid components together in the closed position. The holder is adapted to be fastened to a safety belt of a car or to a personal belt of the bearer by trapping the belt in between the two cover members when the holder is displaced to a closed position.

### BACKGROUND OF THE INVENTION

The invention relates to an identification card holder, and more particularly, but not exclusively, to an emergency identification holder suitable for being removably secured to a safety belt of a motor vehicle.

It is often observed in the emergency situations that the identification and medical information of an injured person is not readily available to the rescue services. This situation may cause unnecessary delays in providing the crucial medical assistance, especially if the person is unconscious. Rapid response and assistance within the first hour plays a critical role in helping to reduce injuries and deaths.

Some identification card holders are available in the trade. However, the presently available identification card holders are not easily accessible to the rescue services as they do not have a standardised location and visibility. Those that are designed to be attached to the safety belt of the car are made of the flexible plastic material that may be easily deformed thus making the information they contain difficult to evaluate. They are wrapped and secured around the belt which makes their retrieval unnecessarily complicated, and time consuming.

It is accordingly an object of this invention to provide an emergency information card holder that will, at least partially, alleviated the above disadvantages.

It is a further object of the invention to provide a new emergency information card holder, which will be a useful alternative to existing emergency information card holders.

It is also an object of this invention to provide a new emergency identification card's holder that is easy to locate and retrieve providing for vital information in the situation of crisis.

### SUMMARY OF THE INVENTION

According to the present invention, there is provided an emergency identification card holder comprising:
two cover members being pivotably secured to one another, the cover members being displaceable between an open position in which the two cover members are angularly spaced apart and in which information housed inside the holder can be accessed, and a closed position in which the two cover members are substantially parallel in order to overlie one another; and
fastening means for fastening the two rigid components together in the closed position;
characterised in that the holder is adapted to be fastened to a safety belt of a car or to a personal belt of the bearer by being configured to trap the belt inbetween the two cover members when the holder is displaced to a closed position.

There is provided for each cover member to include a planar base, with a circumferential skirt depending from an edge of the planar base.

Recesses may be provided in opposing zones of the skirt of at least one of the cover members, the recesses being configured and dimensioned for receiving the belt therein.

There is provided for at least one of the cover members, preferably both, to be adapted to retain a card carrying identification information.

There is provided for the or each cover member to include retaining formations for retaining the card carrying identification information.

Preferably the retaining formations are in the form of inwardly extending spigots extending from the skirt of the cover members, which enables the card to be secured between the spigots and the planar base of a cover member.

The fastening means may be in the form of a resilient clip arrangement including a fastening formation extending from one cover member and a complementary receiving formation extending from the other cover member.

There is also provided for the cover members, fastening means and retaining formations are all integrally formed from a plastic material.

### BRIEF DESCRIPTION OF THE DRAWINGS

An embodiment of the invention is described by way of a non-limiting example only, and with reference to the accompanying figures in which:

FIG. 1 is a perspective view of the emergency identification card's holder;

FIG. 2a is a top view of the holder;

FIG. 2b is a bottom view of the holder;

FIG. 2c is a front view of the holder;

FIG. 2d is a side view of the holder; and

FIG. 3 is a perspective view of the holder in the open position.

### DESCRIPTION OF ONE EMBODIMENT

This invention relates to an emergency identification card holder for attachment to a motor vehicle safety belt, the holder comprising two flat and rigid cover members pivotally attached to each other and having a clip to keep the two rigid components together in a closed position.

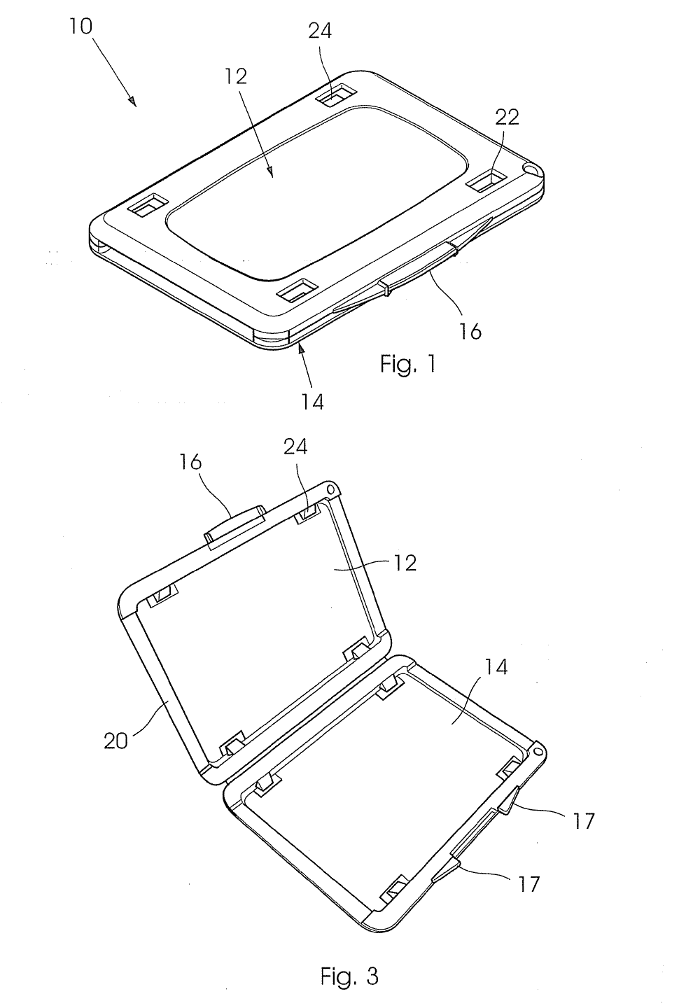

FIG. 1 shows the perspective view of the holder 10 according to the invention. A top flat, elongate cover member 12 is hingedly connected to a bottom flat, elongate cover member 14. Both cover members are made from a sufficiently rigid material resistant to excessive bending and breakages. Both cover members 12 and 14 include recesses 22, positioned in each corner of the flat component, defined by the inwardly extending retainers or spigots 24 for retaining emergency identification cards, placed inside the holder 10. The clip 16 holds both cover members 12 and 14 together in a closed position. The holder can be attached to a key-ring through aperture 30.

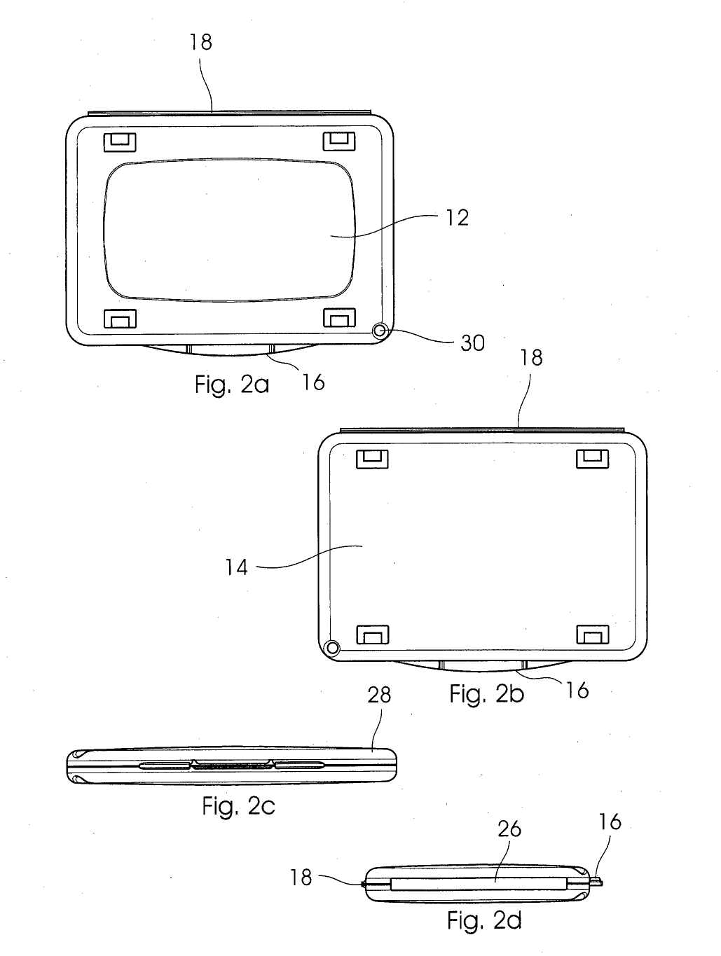

With reference to FIGS. 2a and 2b the top 12 and bottom 14 cover members are pivotally attached to each other by way of a hinge formation 18.

The holder 10 is kept in the closed position by the clip 16 according to FIG. 2C. The holder 10 defines a cavity formed by the presence of the skirt or ridges 28 that extend transversely from the edge of the cover members 12 and 14. This cavity is capable to receive and hold a belt once the holder is clipped in the closed position. The aperture 26 in FIG. 2d allows for a safety belt of the car or personal belt of the bearer to extend outwardly in both directions after the holder had been securely closed over it.

According to FIG. 3 the clipping device consists of the clip 16 positioned in the front of the top cover member 12 and two extensions 17 attached to the bottom cover member 14. Two extensions 17 are adapted to interlock with a clip 16 when the top cover member 12 is closed over the bottom cover member 14. Retainers 24 positioned in the vicinity of the corners of both flat components hold the identification cards securely in place inside of the holder. The indentations 20 present in the ridges on both sides of the top and bottom flat components define the aperture 26 once the holder is in the closed position. It will, however, be appreciated that the fastening arrangement used to secure the card holder in the closed position may take many different forms, and the invention is not limited to any particular embodiment.

The holder 10 is fitted with two emergency identification cards, one for each flat component that normally would specify the necessary personal, medical and contact information. The holder 10 is fastened to the safety belt of the car or to personal belt of the bearer by folding both components longitudinally around a belt and clipping it together. The belt extends outwardly from the holder in both directions through the apertures especially provided for this purpose.

In the emergency situation the holder 10 can be easily identified and unclipped from the belt to provide for all the information needed by the rescue services for speedy assistance.

1. An emergency identification card holder comprising
two cover members being pivotably secured to one another, the cover members being displaceable between an open position in which the two cover members are angularly spaced apart and in which information housed inside the holder can be accessed, and a closed position in which the two cover members are substantially parallel in order to overlie one another; and
fastening means for fastening the two rigid components together in the closed position;
wherein the holder is adapted to be secured to a safety belt of a car or to a personal belt of a bearer, by being configured to trap the belt inbetween the two cover members when the holder is displaced to a closed position.

2. The holder of claim 1, wherein each cover member includes a planar base, with a circumferential skirt depending from an edge of the planar base.

3. The holder of claim 2, wherein recesses are provided in opposing zones of the skirt of at least one of the cover members, the recesses being configured and dimensioned for receiving the belt therein.

4. The holder of claim 3, wherein at least one of the cover members is adapted to retain a card carrying identification information.

5. The holder of claim 4, wherein the cover member includes retaining formations for retaining the card carrying identification information.

6. The holder of claim 5, wherein the retaining formations are in the form of inwardly extending spigots extending from the skirt of the cover members, and which enable the card to be secured between the spigots and the planar base of a cover member.

7. The holder of claim 1, wherein the fastening means is in the form of a resilient clip arrangement including a fastening formation extending from one cover member and a complementary receiving formation extending from the other cover member.

8. The holder of claim 1, wherein the cover members, fastening means and retaining formations are all integrally formed from a plastic material.
